(19) United States
(12) Patent Application Publication
(10) Pub. No.: US 2014/0026001 A1
(43) Pub. Date: Jan. 23, 2014

(54) Method of Improving Data Transmission and Related Computer System

(71) Applicant: WISTRON CORPORATION, New Taipei City (TW)

(72) Inventor: Margaret-Peyi Lin, New Taipei City (TW)

(73) Assignee: WISTRON CORPORATION, New Taipei City (TW)

(21) Appl. No.: 13/688,224

(22) Filed: Nov. 29, 2012

(30) Foreign Application Priority Data
Jul. 19, 2012 (TW) 101126013

(51) Int. Cl. G06F 11/30

(52) U.S. Cl. CPC G06F 11/3003
USPC 714/47.1

(57) ABSTRACT

A method of improving a data transmission for a firmware in a computer system is disclosed. The method includes monitoring a time-out count, a roll-over count, and an error flag of the data transmission when the data transmission is performed via a high-speed bus; and determining whether to send an interrupt command to a BIOS according to the time-out count, the roll-over count, and the error flag.

### BACKGROUND OF THE INVENTION

1. Field of the Invention

The present invention relates to a method of improving a data transmission and a related computer system, and more particularly, to a method of improving a data transmission and a related computer system capable of avoiding a data transmission failure.

2. Description of the Prior Art

Universal serial bus (USB) is a common interface standard utilized for accessing personal computers and its peripheral devices. Recently, the applications of USB have been widely extended to consumer electronic products and portable devices. The interfaces compatible with USB version 2.0 (briefly called USB 2.0 hereinafter) have been widely applied, since USB 2.0 can achieve a maximum transmission rate of 480 Mb/s and possesses compatibility with power supply, such that USB 2.0 interface prevails in personal computers currently. While data storage capacity is improved and network speed enters a “Gigabyte Age”, data connections between computers and peripheral devices require a higher transmission rate. However, USB 2.0 cannot satisfy the requirements for the high growth of access rate.

Therefore, in order to comply with the requirements for a data transmission in a higher speed, USB version 3.0 (briefly called USB 3.0 hereinafter) debuted in November, 2008. USB 3.0 allows a data transmission in an “ultra-high-speed” of 4.8 Gbps and its net data transmission rate may also reach 4 Gbps. When USB 3.0 is operated in an ultra-high-speed data transmission, the two pairs of differential data wires of USB 3.0 apply a full duplex method for signal transmission, which is different from the non-ultra-high-speed pair of differential data wires. Therefore, the transmission wires of USB 3.0 include a power wire, a ground wire, two non-ultra-high-speed data wires, and four ultra-high-speed data wires. In comparison, the transmission wires of USB 2.0 only include a pair of transmission wires (i.e. two data wires) utilized for the data transmission. Besides, under a “host-directed” protocol, the ultra-high-speed data transmission can be set up between the host controller and each peripheral device via a communication channel while USB 2.0 transmits packets to all peripheral devices by broadcasting. Certainly, USB 3.0 possesses many other characteristics different from USB 2.0, which should be well-known by those skilled in the art, and therefore will not be narrated herein.

However, the hardware design problems on the circuits of USB 3.0 (e.g. folded wire problems or connector problems) may cause a transmission failure or an incomplete data transmission during USB 3.0 data transmission.

### SUMMARY OF THE INVENTION

It is therefore an objective of the present invention to provide a method of improving a data transmission for a firmware of a computer system and a related computer system to avoid a data transmission failure.

An embodiment of the invention discloses a method of improving a data transmission for a firmware in a computer system. The method comprises monitoring a time-out count, a roll-over count, and an error flag of the data transmission when the data transmission is performed via a high-speed bus; and determining whether to send an interrupt command to a basic input output system (BIOS) according to the time-out count, the roll-over count, and the error flag.

An embodiment of the invention further discloses a method of improving a data transmission for a basic input output system (BIOS) of a computer system. The method comprises checking a low-speed flag before the data transmission starts; and determining whether to adjust a de-emphasis level according to the low-speed flag, wherein the de-emphasis level is related to a transmission rate of the data transmission.

An embodiment of the invention further discloses a computer system for improving a data transmission. The computer system comprises a firmware for monitoring a time-out count, a roll-over count, and an error flag of the data transmission and determining whether to send an interrupt command according to the time-out count, the roll-over count, and the error flag; and a basic input output system (BIOS) for setting a low-speed flag according to the interrupt command and determining whether to adjust a de-emphasis level according to the low-speed flag.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A and FIG. 1B are schematic diagrams of a process according to an embodiment of the invention.

FIG. 2 is a schematic diagram of a computer system according to an embodiment of the invention.

### DETAILED DESCRIPTION

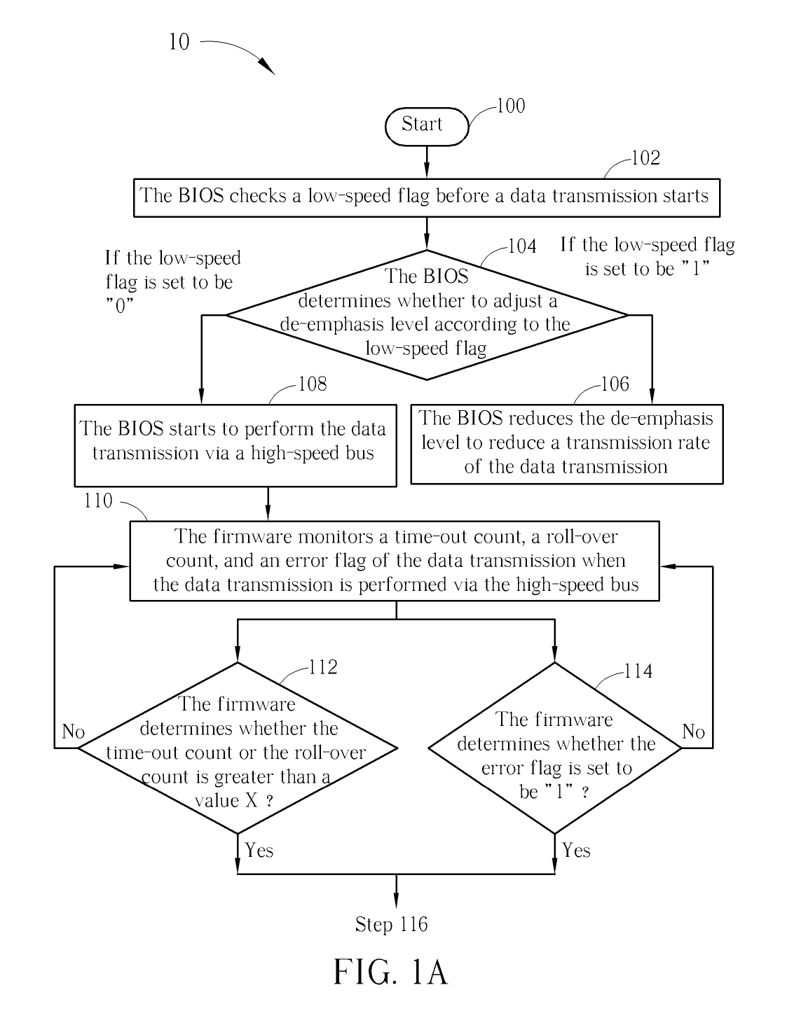

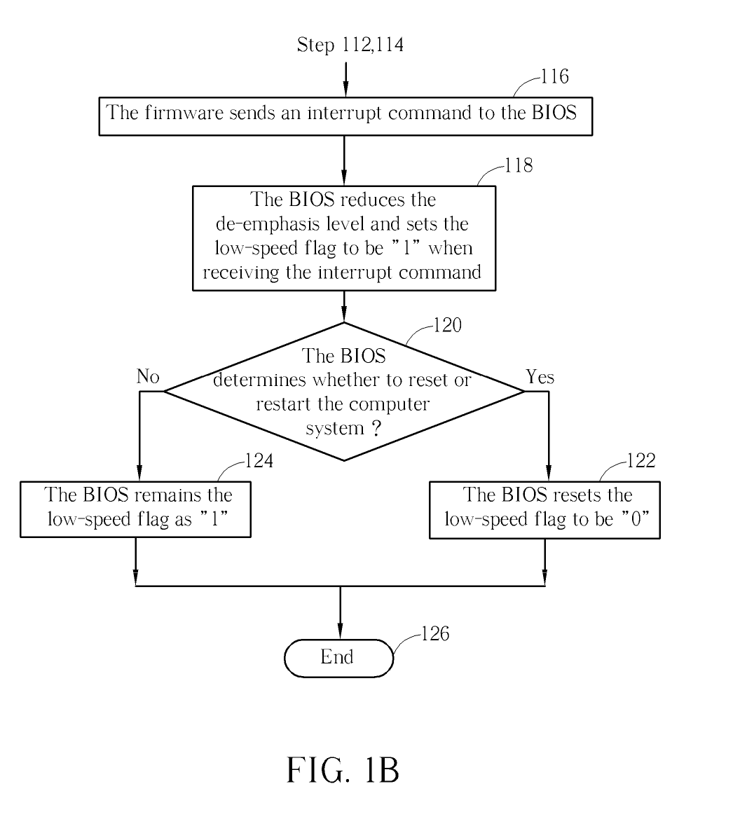

Please refer to FIG. 1A and FIG. 1B, which are schematic diagrams of a process 10 according to an embodiment of the invention. The process 10 is utilized in a computer system, for improving a data transmission for a bus of the computer system to avoid a transmission failure or an incomplete data transmission. The computer system includes a firmware and a basic input output system (BIOS). The bus of the computer system includes universal serial bus (USB), peripheral component interconnect express (PCIe), serial advanced technology attachment (SATA) etc. which are not limited herein. The process 10 includes the following steps:

Step 100: Start.

Step 102: The BIOS checks a low-speed flag before a data transmission starts.

Step 104: The BIOS determines whether to adjust a de-emphasis level according to the low-speed flag. If the low-speed flag is set to be “0”, go to Step 108; if the low-speed flag is set to be “1”, go to Step 106.

Step 106: The BIOS reduces the de-emphasis level to reduce a transmission rate of the data transmission.

Step 108: The BIOS starts to perform the data transmission via a high-speed bus.

Step 110: The firmware monitors a time-out count, a roll-over count, and an error flag of the data transmission when the data transmission is performed via the high-speed bus.

Step 112: The firmware determines whether the time-out count or the roll-over count is greater than a value X. If yes, go to Step 116; otherwise, go to Step 110.

Step 114: The firmware determines whether the error flag is set to be “1”. If yes, go to Step 116; otherwise, go to Step 110.

Step 116: The firmware sends an interrupt command to the BIOS.

Step 118: The BIOS reduces the de-emphasis level and sets the low-speed flag to be “1” when receiving the interrupt command.

Step 120: The BIOS determines whether to reset or restart the computer system. If yes, go to Step 122; otherwise, go to Step 124.

Step 122: The BIOS resets the low-speed flag to be “0”.

Step 124: The BIOS remains the low-speed flag as “1”.

Step 126: End.

According to the process 10, the BIOS of the computer system checks whether the low-speed flag is set to be “0” before the data transmission starts. When the low-speed flag is set to be “0”, the BIOS starts to perform the data transmission via a high-speed bus (e.g. USB 3.0). When the low-speed flag is set to be “1”, the BIOS reduces a de-emphasis level and starts to perform the data transmission via a low-speed bus (e.g. USB 2.0). The de-emphasis level is related to the transmission rate of the data transmission, wherein a higher de-emphasis level means a higher transmission rate, and a lower de-emphasis level means a lower transmission rate. For example, the de-emphasis level may decrease from 6 dB (5 GT/s) to 3.5 dB (2.5 GT/s). If the BIOS starts to perform the data transmission via the high-speed bus (e.g. USB 3.0), the firmware monitors a time-out count, a roll-over count, and an error flag of the data transmission to determine whether an error occurs in the data transmission. Besides, when at least one of a fatal error, an uncorrectable error, and a signal system error occurs in the data transmission, the error flag is set to be “1”. When the time-out count or the roll-over count is greater than a value X, the firmware sends an interrupt command to the BIOS. Preferably, the value X is a predefined value. For example, the time-out count or the roll-over count is greater than 100 or when the error flag is set to be “1”, the firmware sends the interrupt command to the BIOS to inform the BIOS of an error in the data transmission. Thus, the transmission rate of the data transmission has to be reduced. The BIOS therefore reduces the de-emphasis level and sets the low-speed flag to be “1” according to the interrupt command. In this situation, the BIOS determines whether to reset or restart the computer system. When the computer system is reset or restarted, the BIOS resets the low-speed flag to be “0”; when the computer system is not reset or restarted, the BIOS remains the low-speed flag as “1”.

In short, before the data transmission starts, the BIOS determines whether to perform the data transmission via the high-speed bus (e.g. USB 3.0) or the low-speed bus (e.g. USB 2.0) by adjusting the de-emphasis level according to the low-speed flag. During the period of the data transmission via the high-speed bus, the firmware monitors the time-out count or the roll-over count and the error flag to determine whether a transmission error occurs. If the time-out count or the roll-over count exceeds the value X or the error flag is set to be “1”, the firmware sends the interrupt command to the BIOS to inform the BIOS an error occurs in the data transmission, and the transmission rate of the data transmission has to be reduced to avoid a transmission failure or an incomplete data transmission. The BIOS sets the low-speed flag to be “1” to reduce the de-emphasis level according to the interrupt command, and performs the data transmission via the low-speed bus until the computer system is reset or restarted. When the computer system is reset or restarted, the BIOS resets the low-speed flag to be “0”. Therefore, the present invention can utilize the BIOS and the firmware to monitor whether the transmission error occurs during the data transmission via the high-speed bus, so as to adjust the de-emphasis level to avoid a transmission failure or an incomplete data transmission.

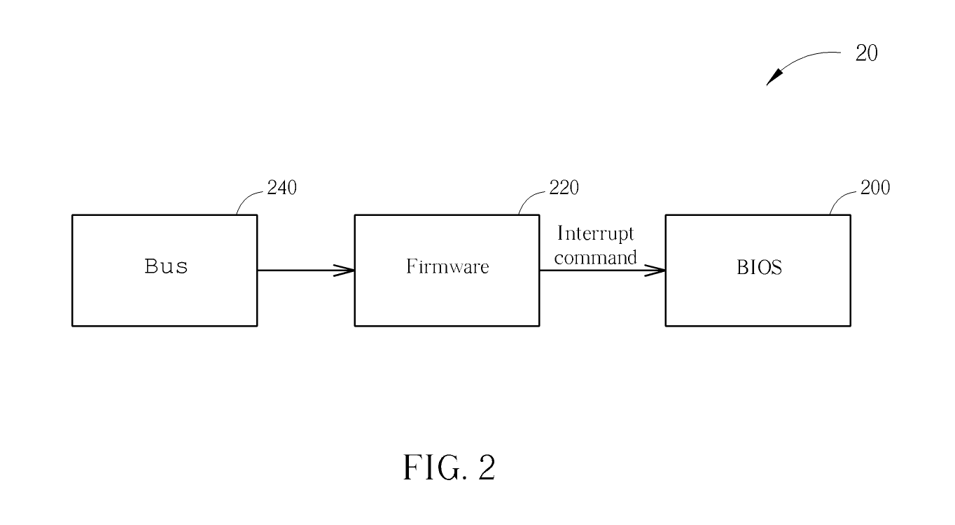

An implementation of the process 10 is illustrated in FIG. 2, which is a schematic diagram of a computer system 20 according to an embodiment of the invention. The computer system 20 includes a BIOS 200, a firmware 220, and a bus 240. The bus 240 includes universal serial bus (USB), peripheral component interconnect express (PCIe), serial advanced technology attachment (SATA) etc. which are not limited herein. The firmware 220 is utilized for monitoring a time-out count, a roll-over count, and an error flag of the data transmission of the bus 240, and determining whether to send an interrupt command to the BIOS 200 according to the time-out count, the roll-over count, and the error flag. The BIOS 200 is utilized for setting a low-speed flag according to the interrupt command and determining whether to adjust a de-emphasis level according to the low-speed flag.

The computer system 20 in FIG. 2 is utilized for implement the process 10. The related operation can be found, and will not be narrated herein.

To sum up, according to the present invention, the BIOS adjusts the de-emphasis level according to the low-speed flag before the data transmission starts. During the data transmission via the high-speed bus, the firmware monitors the time-out count or the roll-over count and the error flag. If the time-out count or the roll-over count exceeds the value X or the error flag is set to be “1”, the firmware sends the interrupt command to the BIOS. The BIOS sets the low-speed flag to be “1” according to the interrupt command to reduce the de-emphasis level, so as to reduce the transmission rate of the data transmission. When the computer system is reset or restarted, the BIOS resets the low-speed flag to be “0”. Therefore, the present invention can utilize the BIOS and the firmware to monitor whether a transmission error occurs during the data transmission via the high-speed bus, so as to adjust the de-emphasis level to avoid a transmission failure or an incomplete data transmission.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of improving a data transmission for a firmware in a computer system, the method comprising:
monitoring a time-out count, a roll-over count, and an error flag of the data transmission when the data transmission is performed via a high-speed bus; and
determining whether to send an interrupt command to a basic input output system (BIOS) according to the time-out count, the roll-over count, and the error flag.

2. The method of claim 1, wherein determining whether to send the interrupt command to the BIOS according to the time-out count and the roll-over count comprises sending the interrupt command to the BIOS when the time-out count or the roll-over count is greater than a threshold value.

3. The method of claim 1, wherein determining whether to send the interrupt command to the BIOS according to the error flag comprises sending the interrupt command to the BIOS when the error flag is set to be “1”.

4. The method of claim 3 further comprising setting the error flag to be “1” when at least one of a fatal error, an uncorrectable error, and a signal system error occurs.

5. A method of improving a data transmission for a basic input output system (BIOS) of a computer system, the method comprising:
checking a low-speed flag before the data transmission starts; and
determining whether to adjust a de-emphasis level according to the low-speed flag, wherein the de-emphasis level is related to a transmission rate of the data transmission.

6. The method of claim 5, wherein determining whether to adjust the de-emphasis level according to the low-speed flag comprises starting to perform the data transmission via a high-speed bus when the low-speed flag is set to be “0” and reducing the de-emphasis level to reduce the transmission rate of the data transmission when the low-speed flag is set to be “1”.

7. The method of claim 6, wherein reducing the transmission rate of the data transmission comprises starting to perform the data transmission via a low-speed bus.

8. The method of claim 5 further comprising reducing the de-emphasis level and setting the low-speed flag to be “1” when receiving an interrupt command, wherein the interrupt command is related to a transmission error of the data transmission.

9. The method of claim 8, wherein the transmission error of the data transmission comprises at least one of a time-out count or a roll-over count of the data transmission greater than a threshold value, occurrence of a fatal error, occurrence of an uncorrectable error, and occurrence of a signal system error.

10. The method of claim 8 further comprising determining whether to reset or restart the computer system when the low-speed flag is set to be “1”.

11. The method of claim 10 further comprising resetting the low-speed flag to be “0” when determining to reset or restart the computer system.

12. The method of claim 10 further comprising remaining the low-speed flag as “1” when determining not to reset or restart the computer system.

13. A computer system for improving a data transmission, the computer system comprising:
a firmware, for monitoring a time-out count, a roll-over count, and an error flag of the data transmission and determining whether to send an interrupt command according to the time-out count, the roll-over count, and the error flag; and
a basic input output system (BIOS), for setting a low-speed flag according to the interrupt command and determining whether to adjust a de-emphasis level according to the low-speed flag.

14. The computer system of claim 13, wherein the firmware determining whether to send the interrupt command to the BIOS according to the time-out count and the roll-over count comprises the firmware sending the interrupt command to the BIOS when the time-out count or the roll-over count is greater than a threshold value.

15. The computer system of claim 13, wherein the firmware determining whether to send the interrupt command to the BIOS according to the error flag comprises the firmware sending the interrupt command to the BIOS when the error flag is set to be “1”.

16. The computer system of claim 13, wherein the firmware is further utilized for setting the error flag to be “1” when at least one of a fatal error, an uncorrectable error, and a signal system error occurs.

17. The computer system of claim 13, wherein the BIOS is further utilized for checking the low-speed flag before a data transmission starts.

18. The computer system of claim 13, wherein the BIOS determining whether to adjust the de-emphasis level according to the low-speed flag comprises starting to perform the data transmission via a high-speed bus when the low-speed flag is set to be “0” and reducing the de-emphasis level to reduce the transmission rate of the data transmission when the low-speed flag is set to be “1”.

19. The computer system of claim 18, wherein the BIOS reducing the transmission rate of the data transmission comprises the BIOS starting to perform the data transmission via a low-speed bus.

20. The computer system of claim 13, wherein the BIOS setting the low-speed flag according to the interrupt command comprises the BIOS reducing the de-emphasis level and setting the low-speed flag to be “1” when receiving the interrupt command.

21. The computer system of claim 20, wherein the BIOS is further utilized for determining whether to reset or restart the computer system when the low-speed flag is set to be “1”.

22. The computer system of claim 21, wherein the BIOS is further utilized for resetting the low-speed flag to be “0” when determining to reset or restart the computer system.

23. The computer system of claim 21, wherein the BIOS is further utilized for remaining the low-speed flag as “1” when determining not to reset or restart the computer system.
